(19) United States
(12) Patent Application Publication
(10) Pub. No.: US 2002/0107043 A1
(43) Pub. Date: Aug. 8, 2002

(54) Cordless phone apparatus

(76) Inventors: Alan D. Adamson, San Diego, CA (US); Robert M. Davidson, Santee, CA (US); John D. Turner, San Diego, CA (US)

Correspondence Address: Katherine Proctor, Brown, Martin, Haller & McClain, LLP, 1660 Union Street, San Diego, CA, 92101-2926, US

(21) Appl. No.: 10/039,681

(22) Filed: Jan. 4, 2002

Related U.S. Application Data
(63) Continuation-in-part of application No. 29/135,859, filed on Jan. 19, 2001.
(63) Continuation-in-part of application No. 29/152,136, filed on Dec. 13, 2001.

(51) Int. Cl. H04M 1/00

(52) U.S. Cl. 455/550; 455/569

(57) ABSTRACT

A wireless telephone apparatus has a handset and a base unit having a cradle for removably supporting the handset. The base unit contains a charger for connection to the handset when supported in the cradle, and has a hinge joint rotatably connecting the cradle to the base unit. The hinge joint has a first part on the second wall and a second part on the cradle which is rotatably connected to the first part to allow the cradle to be rotated into any one of a plurality of different orientations relative to the base housing.

### CROSS-REFERENCES TO RELATED APPLICATIONS

This application is a Continuation-In-Part of Design Application Serial No. 29/135,859 filed Jan. 19, 2001 and Design Application Serial No. 29/152,136 filed Dec. 13, 2001.

### BACKGROUND OF THE INVENTION

This invention relates to a cordless phone apparatus including a base unit and a cordless phone unit for location in a cradle on the base unit.

The base unit of a cordless phone apparatus typically includes at least a charging device for charging a battery of the cordless phone unit, and may also include transceiver circuitry for connecting the cordless phone to the telephone system via a radio link. In some cases, the transceiver circuitry is provided in a base station separate from the charging unit. The base unit may take up a relatively large amount of desk or table top space and the cordless phone unit is typically held in a fixed position in the cradle.

### SUMMARY OF THE INVENTION

It is an object of the present invention to provide a new and improved wireless telephone apparatus.

According to the present invention, a wireless telephone apparatus is provided, which comprises a wireless telephone and a base unit having a cradle for removably supporting the telephone and a base housing containing at least a charger for connection to the telephone when supported in the cradle, the base housing having a first wall for placing against a mounting surface and a second wall facing in the opposite direction to the first wall, and a hinge having a first part mounted on the second wall and a second part on the cradle which is rotatably connected to the first part to allow the cradle to be rotated into any one of a plurality of different orientations relative to the base housing.

In an exemplary embodiment of the invention, the first wall is generally flat and has feet for selectively standing the base housing on a desk, table top, or other horizontal surface, as well as at least one hook formation for selectively suspending the base housing from a wall hanger or the like with the first wall in a vertical orientation. The base housing may include base station transceiver circuitry for linking the cordless phone to the telephone system as well as the charger for re-charging the phone battery. Alternatively, a separate base station may be provided.

Wiring extends from the charger circuitry within the housing through the hinge for connection to the contacts in the cradle. In an exemplary embodiment of the invention, the first part of the hinge comprises a hinge arm on the second wall of the housing having a hinge recess with spaced end walls, and a hinge pin extending between the end walls, and the second part comprises a hinge sleeve rotatably mounted on the hinge pin for rotation about a hinge axis. The hinge sleeve is in frictional engagement with the hinge pin such that it will be held in any selected rotated position until positively urged by a user into a new position. A phone supported in the cradle is rotatable between a first position generally parallel to or adjacent the first wall of the housing, in which the cradle rests against the second wall of the housing, and any selected orientation inclined relative to the first position within a predetermined angular range. Thus, the phone may be positioned in the first position when the base housing is hung vertically from a wall hanger or the like, and may be positioned at any desired angular position when the base housing is placed on a desk or other horizontal surface, so that a user may readily view the display and access the keypad.

### BRIEF DESCRIPTION OF THE DRAWINGS

The present invention will be better understood from the following detailed description of an exemplary embodiment of the invention, taken in conjunction with the accompanying drawings in which like reference numerals refer to like parts and in which:

FIG. 1 is a front perspective view of the cordless phone handset and base of a cordless phone apparatus according to an exemplary embodiment of the invention.

FIG. 2 is a rear perspective view thereof;

FIG. 3 is a top plan view of the base with the cradle in upright position;

FIG. 4 is a rear view of the base;

FIG. 5 is a bottom view of the base;

FIG. 6 is a side view showing the base attached to a wall with the handset upright;

FIG. 7 is a rear view of the handset with the addition of a belt clip;

FIG. 8 is a side view of the handset with the belt clip;

FIG. 9 is an enlarged, partial cross-sectional view through the pivot joint on the lines 9-9 of FIG. 1, illustrating the wiring path through the joint; and

FIG. 9A is a perspective view of the hinge pin.

### DETAILED DESCRIPTION OF THE DRAWINGS

FIGS. 1 to 9A illustrate a cordless phone apparatus 10 according to an exemplary embodiment of the present invention. The apparatus 10 basically comprises a base 12 and a cordless phone handset 14 releasably supported in a cradle 16 which is rotatably mounted on the base 12 via a hinge assembly or joint 18.

Base 12 comprises a housing having a first, generally flat wall 20 a second, convex or slightly upwardly rounded wall 22 facing away from wall 20, and a circular peripheral rim 24. The housing has an optional, conventional cordless phone base station antenna 21 and page button 23. A conventional cordless phone charger circuit and base transceiver (not illustrated) for connection to the telephone network are provided within the base housing. Alternatively, as described in co-pending design patent application No. 29/135,841 entitled “Cordless Phone Base Station and Hanger” and No. 29/135,859 enttiled “Cordless Phone and Base”, both filed Jan. 19, 2001, the contents of which are incorporated herein by reference, the base transceiver may be provided in a separate base station, with the housing containing only the phone charger circuit. A first part of the hinge joint 18 is intergrally formed with the second wall 22 of the base housing, and comprises an upstanding hinge bracket or arm 25 having a pivot receptacle 38 with end walls 26 and a separate hinge pin 28 secured between the end walls.

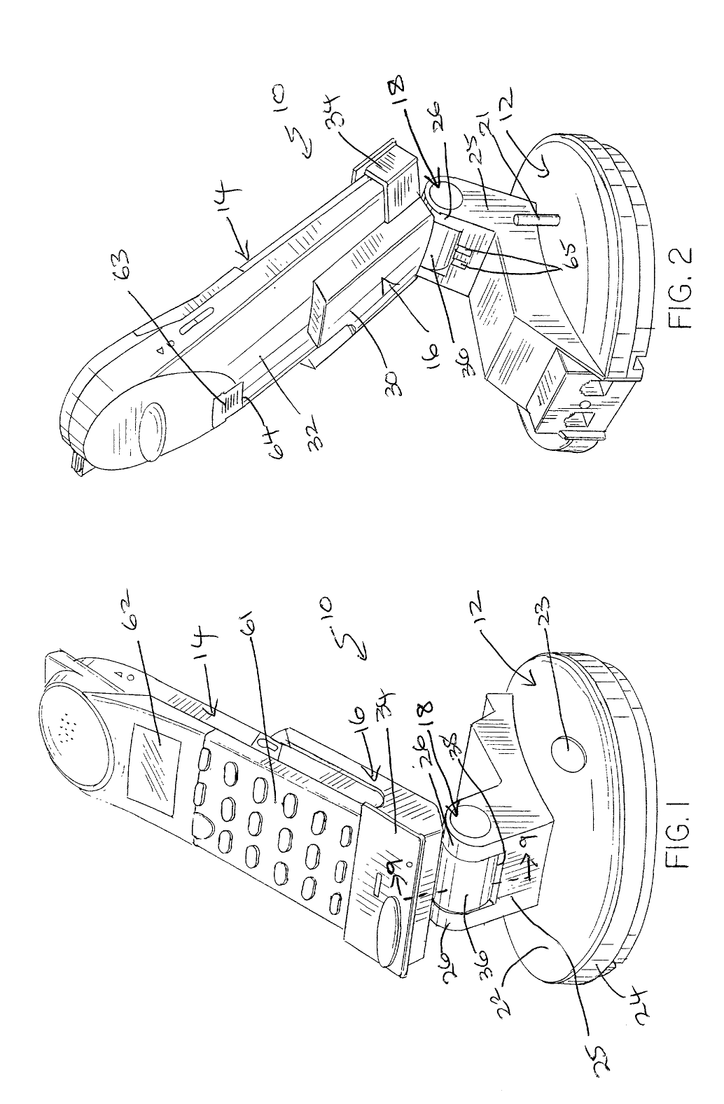

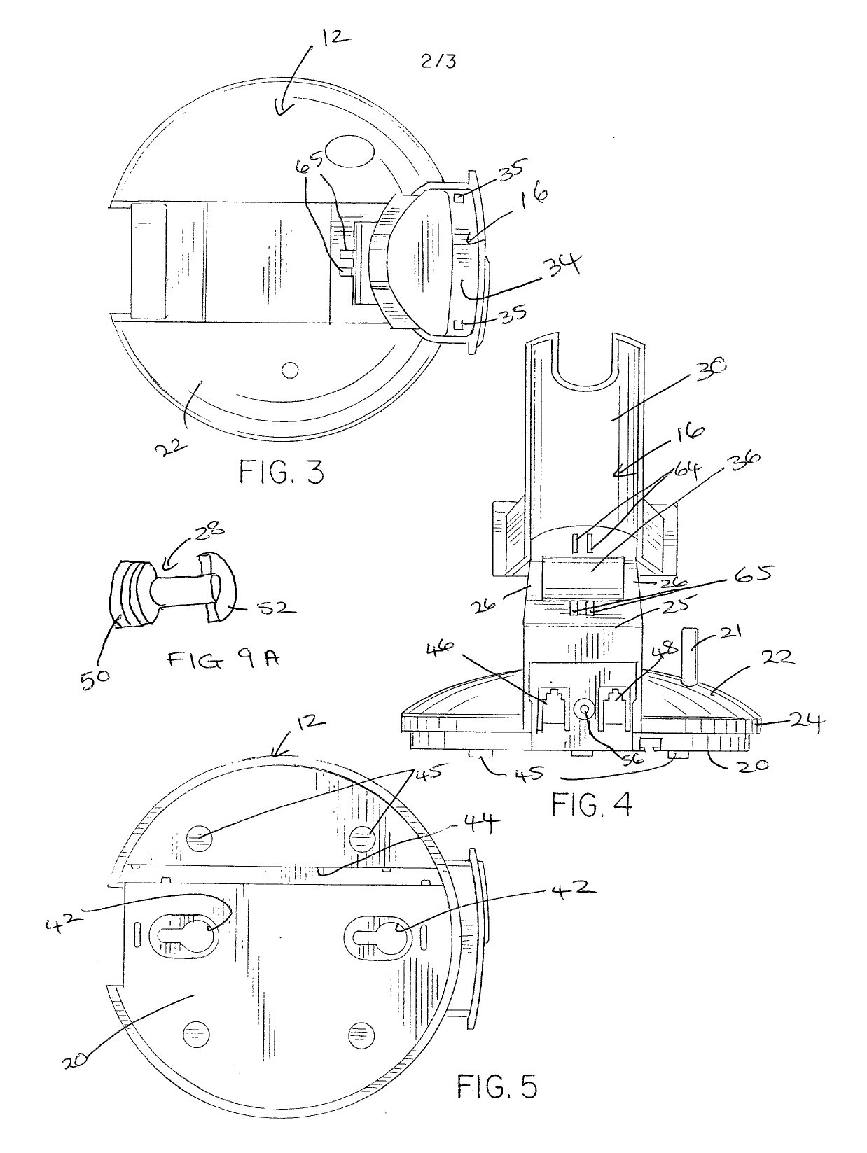

The cradle 16 has a rounded rear wall 30 matching the curvature of the rear wall 32 of the phone 14, and a recessed lower end 34 shaped to receive a lower end portion of the phone as indicated in FIGS. 1 and 2, with the rear wall 32 of the phone supported against the rear wall of the cradle. A pair of electrical contacts 35 (see FIG. 3) in the lower end of the cradle engage corresponding, conventional contacts (not illustrated) at the lower end of the phone when the phone is mounted in the cradle, so as to connect the base to the battery and circuits within the phone for charging and data/signal communication purposes.

A pivot sleeve 36 is integrally formed on an outer wall at the lower end of the cradle, and is rotatably mounted over pivot pin 28 in pivot receptacle 38, as best indicated in FIGS. 1,2,4,6 and 9. As illustrated in FIG. 9A, pin 28 has enlarged annular end portions 50 at one end, and a semi-annular end portion 52 at the opposite end. The sleeve 36 is a frictional fit over enlarged end portions 50, 52 of pin 28, such that it will be held in any selected rotated position on pin 28 unless the cradle is positively urged by a user into a new position. Wiring 40 extends from the contacts 35 on the cradle through an opening 39 at the center of the sleeve, into the central region of the sleeve surrounding the reduced diameter central portion of pin 28, as best illustrated in FIG. 9. From this point, it exits via a pass-through opening 54 in one end wall 26 of the pivot bracket and through an opening 55 in hinge or pivot receptacle 38 into the base housing, for suitable connection to circuitry within the housing.

As best illustrated in FIG. 5, the first wall 20 of the base housing has a pair of hanger slots 42, and a wiring recess or groove 44 running parallel to a line connecting slots 42. A series of feet 45 of resilient material such as rubber are provided on the first wall 20, for use when the base is stood horizontally on a desk or other horizontal support surface. A conventional telephone line jack 46 and an optional PC data jack 48 are provided on the rear rim of the housing, as indicated in FIG. 4. A power input 56 is provided between the jacks, or may be provided at an alternative location on the base.

This arrangement permits the base 12 to be stood horizontally on a table, desk, or the like, as generally indicated in FIGS. 1 and 2, or alternatively suspended from wall mounted hangers or screws 58 which are hooked into hanger slots 42, as indicated in FIG. 6. This permits the base 12 to be hung in a vertical orientation on a wall 60 or other vertical surface, as best illustrated in FIG. 6.

The pivot joint 18 permits the cradle 16 supporting the phone 14 to be rotated into any desired orientation relative to the base housing, and then to remain in the selected orientation unless moved by the user. The cordless phone 14 has a conventional user key pad 61 and optional display window 62, and the user can rotate the cradle until the phone is in the best orientation for viewing the window 62 or accessing the keypad, for example. When the base is suspended vertically on a wall or the like, as in FIG. 6, the cradle will be pivoted downwardly until rear wall 30 contacts the second wall of the housing, as indicated. In this position, the phone 14 is oriented in an upright, generally vertical or slightly rearwardly inclined orientation for secure retention in the lower end recess 34 of the cradle.

If the user wishes to place the base housing on a horizontal surface, the cradle 16 may still be oriented in the first position illustrated in FIG. 6, if desired. In this orientation, a pair of rearwardly projecting flanges or fins 64 on the outside of the cradle adjacent the pivot sleeve 36 engage in a corresponding pair of slots 65 in the pivot arm 25 (see FIGS. 3,4 and 6). This provides for better alignment and stability. In alternative embodiments, the fins and slots may be eliminated. With the base housing supported horizontally, the user may prefer to tilt the cradle upwardly, rotating in a clockwise direction from the first position into the position illustrated in FIGS. 1 and 2, for example, or into a position at any desired angle relative to the base. The cradle is rotatable through an angular range of over 90 degrees from the generally flat position against the base, which is illustrated in FIG. 6 but which may also be used, if desired, when the base is horizontal. Thus, the cradle may be readily oriented at any suitable angle so that the display 62 can be viewed easily and the keypad 61 can be accessed.

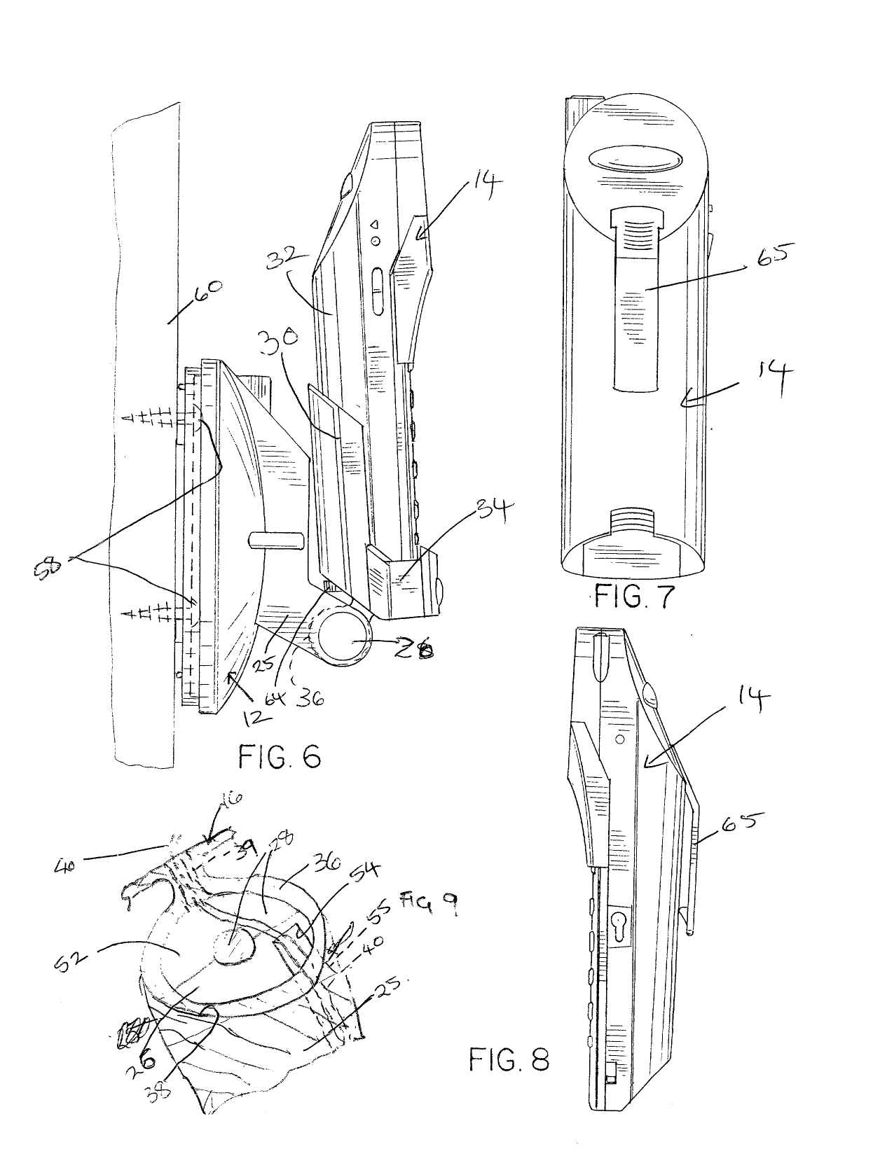

The cordless phone 14 comprises an outer housing containing conventional phone circuitry. A releasable clip 63 is snap engaged in a recess 64 in the rear wall of the housing, as indicated in FIG. 2. The clip is substantially flush with the housing rear wall. If desired, clip 63 may be removed and replaced with a belt clip 65, as illustrated in FIGS. 7 and 8, which has a similar snap engagement in the recess 64. In this way, the phone may be clipped to a belt or waistband as the phone is carried around by a user.

The cordless phone apparatus of this invention is versatile, in that the base may be selectively stood flat on a table, desk or other flat surface, or hung vertically from a wall or the like. At the same time, the phone, when supported in the cradle, may be readily oriented at any desired orientation relative to the base.

Although an exemplary embodiment of the invention has been described above by way of example only, it will be understood by those skilled in the field that modifications may be made to the disclosed embodiment without departing from the scope of the invention, which is defined by the appended claims.

We claim:

1. A wireless telephone apparatus, comprising:
a wireless telephone handset;
a base unit having a cradle for removably supporting the telephone handset, a base housing containing at least a charger for connection to the handset when supported in the cradle, and a hinge joint rotatably connecting the cradle to the base housing;
the base housing having a first wall for placing against a mounting surface and a second wall facing in the opposite direction to the first wall; and
the hinge joint having a first part on the second wall and a second part on the cradle which is rotatably connected to the first part to allow the cradle to be rotated into any one of a plurality of different orientations relative to the base housing.

2. The apparatus as claimed in claim 1, wherein the first part of the hinge joint comprises a hinge arm on the second wall of the housing having a hinge receptacle with spaced end walls and a hinge pin extending between the end walls, and the second part comprises a hinge sleeve rotatably mounted on the hinge pin for rotation about a hinge axis.

3. The apparatus as claimed in claim 2, wherein the hinge sleeve is in rotational frictional engagement with at least a portion of the hinge pin, whereby the sleeve will be held in any selected orientation relative to the hinge pin unless positively urged into a new orientation.

4. The apparatus as claimed in claim 1, wherein the cradle is rotatable through a predetermined angular range between a first end position lying against the second wall of the housing and a second end position.

5. The apparatus as claimed in claim 4, wherein the angular range is greater than ninety degrees.

6. The apparatus as claimed in claim 1, wherein the cradle has a recess at a first end for receiving a lower end portion of the handset, the recess having an inner surface and an outer surface, the second part of the pivot joint being located on the outer surface of the recess, and a pair of electrical contacts mounted on the inner surface of the recess for contacting corresponding contacts on the handset when the handset is mounted in the cradle, and wiring extends from the contacts through the hinge joint and into the base housing for connection to electrical circuits in the housing.

7. The apparatus as claimed in claim 1, wherein the first wall has at least one slot for selectively suspending the base housing from a wall hanger or the like with the first wall in a vertical orientation.

8. The apparatus as claimed in claim 7, wherein the first wall is a substantially flat surface and has feet for selectively standing the base housing on a horizontal surface.

9. The apparatus as claimed in claim 1, wherein the housing has an annular peripheral rim, and the second wall is of a generally convex shape.

10. The apparatus as claimed in claim 1, wherein the first part of the hinge joint includes a hinge arm formed integrally with the second wall of the housing, the hinge arm comprising a hinge recess and a pair of end walls, and the first part further includes a hinge pin secured between the end walls.

11. The apparatus as claimed in claim 10, wherein the second part of the hinge joint comprises a hinge sleeve integrally formed with the cradle and rotatably engaged over the hinge pin.
